(19) United States
(12) Patent Application Publication
(10) Pub. No.: US 2012/0242618 A1
(43) Pub. Date: Sep. 27, 2012

(54) FINGER DEVICE FOR OPERATING A CAPACITIVE TOUCH SCREEN

(76) Inventors: John EVEREST, Orlando, FL (US); Graciela EVEREST, Orlando, FL (US)

(21) Appl. No.: 13/429,781

(22) Filed: Mar. 26, 2012

Related U.S. Application Data
(60) Provisional application No. 61/467,530, filed on Mar. 25, 2011.

(51) Int. Cl. G06F 3/044

(52) U.S. Cl. 345/174

(57) ABSTRACT

A finger device is for operating a portable electronic device that includes a capacitive touch screen. The finger device includes a finger receiving body that includes a bottom surface having a pointed first end and a broad second end, and a pair of spaced apart sidewalls extending outwards from the bottom surface, and forming a finger receiving opening at the broad second end and forming a closed tip at the pointed first end. A finger attachment assembly is for securing the finger receiving body to a user's finger. An electrically conductive material is on a portion of the bottom surface of the finger receiving body and on a portion of the pair of spaced apart sidewalls for contacting the capacitive touch screen for operating the portable electronic device.

### RELATED APPLICATION

This application claims the benefit of U.S. Provisional Application Ser. No. 61/467,530 filed Mar. 25, 2011, the entire contents of which are incorporated herein by reference.

### FIELD OF THE INVENTION

The present invention relates to capacitive touch screens, and more particularly, to a finger device for operating a capacitive touch screen.

### BACKGROUND OF THE INVENTION

Consumer devices increasingly rely on capacitive touch screen inputs as an alternative to physical inputs. Capacitive touch screen technology is largely displacing resistive touch screens due to industrial design, durability, and performance considerations. The Apple iPhone® is an example of a device that operates based on capacitive touch screen technology.

Capacitive touch screen inputs include virtual buttons and sliders displayed on a touch screen. These devices advantageously enable a user to interact directly with the display rather than indirectly with a cursor controlled by a mouse or touchpad. Capacitive touch screen technology thus detects the presence and location of a finger touch within a display area.

Generally, capacitive touch screens require “bare-handed” contact to sense a touch because the touch pad senses the fleshy fingertip due to the conductivity of the flesh. A drawback of capacitive touch screens is that natural oils from the user's finger can leave the display looking dirty and grimy over time. A dirty and grimy touch screen reduces clarity, as well as making it more difficult for the finger to slide across the touch screen.

One approach to addressing this problem is for the user to wear a capacitive sensor glove, as disclosed in U.S. 2010/0090966. An electrically conductive material is disposed at a tip of at least one of the fingers of the glove. When the tip of the finger is brought in contact with a capacitive touch screen, the electrically conducting material causes the touch screen to operate. However, wearing a glove can be rather cumbersome.

Another approach is disclosed in U.S. 2009/0278818 which provides a tap device that is worn on a finger of a user. The tap device includes a base and an associated sleeve that is worn around the user's thumb, for example. A conductive nib projects outwardly from an opposite side of the base and contacts the touch screen. A conductive post extends through an opening in the base and links the nib to a conductive seat portion that contacts the user's thumb. However, positioning of the conductive nib on the touch screen requires precision by the user.

Even in view of the above approaches for operating a capacitive touch screen without requiring the user's finger to directly contact the touch screen, there is still a need to improve upon this concept.

### SUMMARY OF THE INVENTION

In view of the foregoing background, it is therefore an object of the present invention to a straightforward finger device for operating a capacitive touch screen.

This and other objects, advantages and features in accordance with the present invention are provided by a portable electronic device and a finger device for operating the portable electronic device. The portable electronic device comprises a capacitive touch screen.

The finger device comprises a finger receiving body comprising a bottom surface having a pointed first end and a broad second end, and a pair of spaced apart sidewalls extending outwards from the bottom surface, and forming a finger receiving opening at the broad second end and forming a closed tip at the pointed first end. A finger attachment assembly is coupled to the pair of spaced apart sidewalls at the broad second end for securing the finger receiving body to a user's finger. An electrically conductive material is on a portion of the bottom surface of the finger receiving body and on a portion of the pair of spaced apart sidewalls for contacting the capacitive touch screen for operating the portable electronic device.

The finger attachment assembly may comprise hook and loop fasteners. Alternatively, the finger attachment assembly may comprise a pair of curved extensions extending outwards from the pair of spaced apart sidewalls, with a gap between outer exposed ends of the pair of curved extensions. Each curved extension is flexible to accommodate different size fingers.

The finger receiving body and the finger attachment assembly may be formed as a single piece. The finger receiving body may comprise flexible plastic. The upper portion of the finger receiving body is open between the pointed first end and the broad second end to expose an upper portion of the user's finger.

The portable electronic device and the finger device may further comprise a storage attachment assembly for attaching the finger device to the portable electronic device when not in use. The storage attachment assembly may comprises hook and loop fasteners. Alternatively, the storage attachment assembly may comprise a first magnetic strip carried by the portable electronic device, and a second magnetic strip carried by the finger device, with the first and second magnetic strips having opposite polarities. At least one of the first and second magnetic strips may be embedded within the portable electronic device and the finger device.

### BRIEF DESCRIPTION OF THE DRAWINGS

FIG. 1 is a perspective view of a user wearing a finger device while operating a touch screen in accordance with the present invention.

FIG. 2 is a side perspective view of the user's finger wearing the finger device shown in FIG. 1.

FIG. 3 is a top perspective view of a finger device in accordance with the present invention.

FIG. 4 is a bottom perspective view of a finger device in accordance with the present invention.

FIG. 5 is a side perspective view of a finger device in accordance with the present invention.

FIG. 6 is a side perspective view of another embodiment of the finger device in accordance with the present invention.

FIG. 7 is a top perspective view of the finger device attached to a side of a portable electronic device when not in use in accordance with the present invention.

FIG. 8 is a side perspective view of the finger device and the portable electronic device illustrating in greater detail the finger attachment assembly shown in FIG. 7.

FIG. 9 is a side perspective view of the finger device and the portable electronic device illustrating in greater detail another embodiment of the finger attachment assembly shown in FIG. 7.

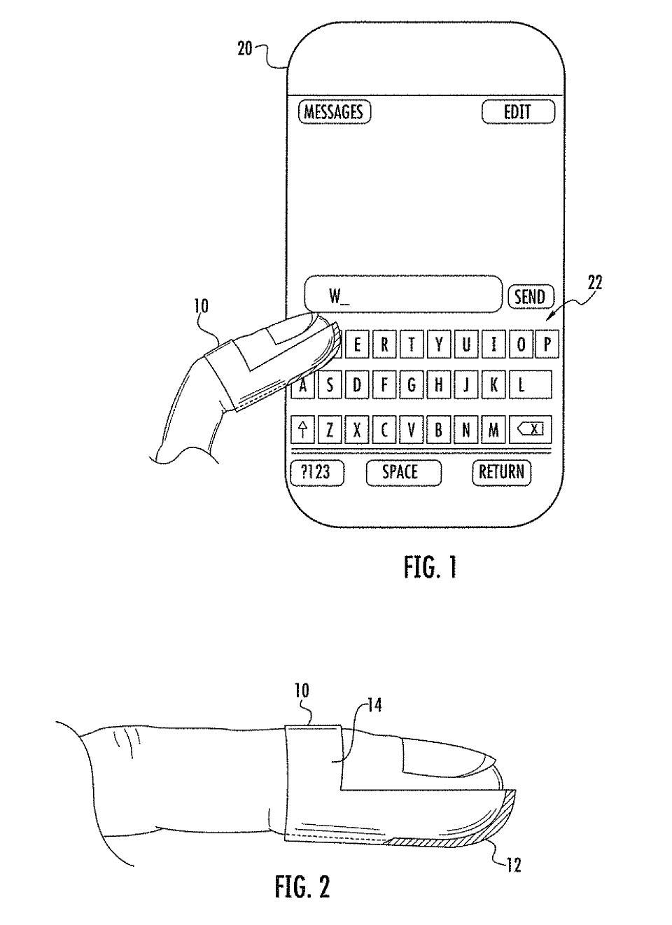

### DETAILED DESCRIPTION OF THE PREFERRED EMBODIMENTS

The present invention will now be described more fully hereinafter with reference to the accompanying drawing, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and double prime notations are used to indicate similar elements in alternative embodiments.

Referring now to FIG. 1, a finger device 10 is worn by the user to operate the touch screen 22 of a portable electronic device 20. The finger device 10 is open tipped to expose the top part of the finger. To insure user flexibility when wearing the finger device 10, such as on an index finger, the device starts at the tip of the finger and ends before the middle knuckle.

Alternatively, when worn on the thumb, the finger device 10 would fit over the tip of the thumb as well as over the middle knuckle. In some cases, the user may wear at least two finger devices 10, one on the index finger and one on the thumb.

The finger device 10 may be formed out of plastic, for example. However, the underside of the finger device 10 includes an electrically conductive material 12 to engage sensors within the touch screen 22. Since the electrically conductive material 12 of the finger device 10 contacts the touch screen 22 in stead of the user's finger, this keeps the touch screen clear by avoiding the natural oils from the finger leaving the display looking dirty and grimy over time. A dirty and grimy screen reduces clarity, as well as making it more difficult for the finger to slide across the touch screen.

As an alternative to use of the electrically conductive material 12, alternative materials may be used, as readily appreciated by those skilled in the art. In some applications, the finger device 10 may be used on non-capacitive touch screens which would not require electrically conductive material 12. Instead, non-electrically conductive material may be used.

In addition, the finger device 10 allows the user to have better accuracy when operating the touch screen 22 due to its pointed tip. A pointed tip reduces the chances of the user selecting the wrong key on the touch screen 22, particularly on compact screens. Alternatively, in lieu of a pointed tip, the tip may be configured to have a subtle protrusion while still allowing for user accuracy.

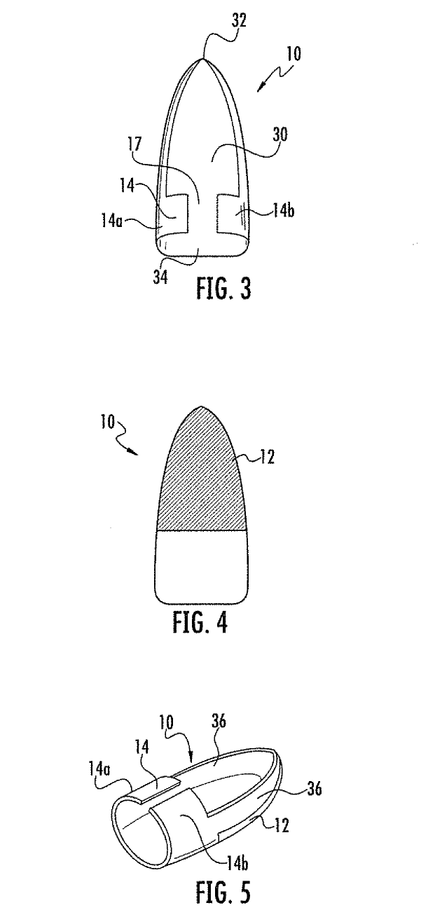

Referring now to FIGS. 3, 4 and 5, the finger device 10 includes a finger receiving body that includes a bottom surface 30 having a pointed first end 32 and a broad second end 34. A pair of spaced apart sidewalls 36 extend outwards from the bottom surface 30, and form a finger receiving opening at the broad second end 34 and form a closed tip at the pointed first end 32. A finger attachment assembly 14 is coupled to the pair of spaced apart sidewalls 36 at the broad second end 34 for securing the finger receiving body to a user's finger, An electrically conductive material 12 is on a portion of the bottom surface 30 of the finger receiving body and on a portion of the pair of spaced apart sidewalls 36 for contacting the capacitive touch screen 22 for operating the portable electronic device 20.

The electrically conductive material 12 covers the underside of the bottom surface 30 of the finger receiving body from the outermost tip 32 to where the finger attachment area 14 begins. The electrically conductive material 12 also continues up a portion of the sidewalls 36 of the finger device 10 so as to accommodate the user twisting their finger to the side when sliding across the capacitive touch screen 22. Alternatively, the electrically conductive material 12 may completely cover the underside of the finger device 10.

In the illustrated embodiment, the finger attachment assembly 14 includes a pair of curved extensions 14a, 14b extending outwards from the pair of spaced apart sidewalls 36, with a gap 17 between outer exposed ends of the pair of curved extensions. Each curved extension 14a, 14b is flexible to accommodate different size fingers. As illustrated, the finger receiving body and the finger attachment assembly are formed as a single piece. The finger receiving body may comprise flexible plastic, for example.

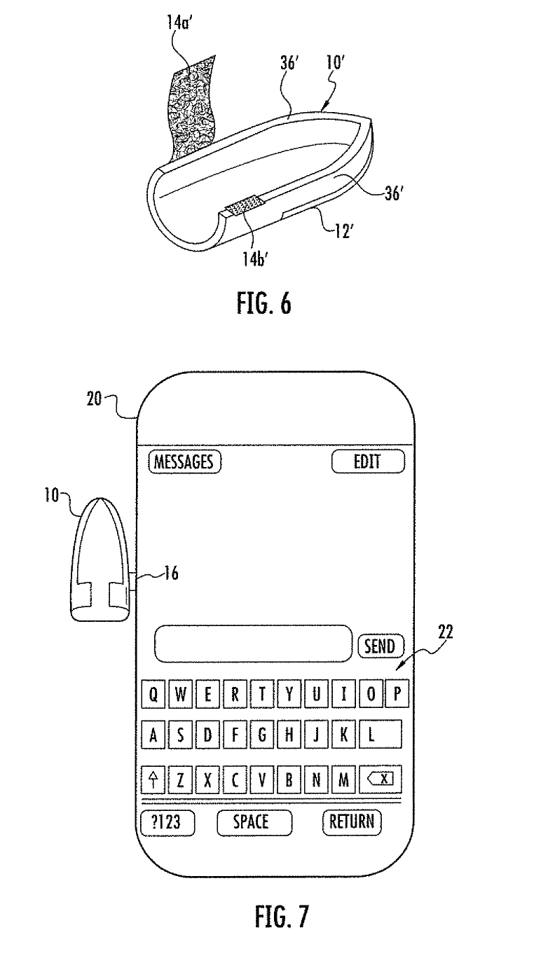

The upper portion of the finger receiving body is open between the pointed first end 32 and the broad second end 34 to expose an upper portion of the user's finger. An alternative embodiment to the finger attachment assembly 14′ is provided in FIG. 6. Here, the finger attachment assembly 14′ comprises hook and loop fasteners. For example, strap portion 14a′ is secured to strap portion 14b′.

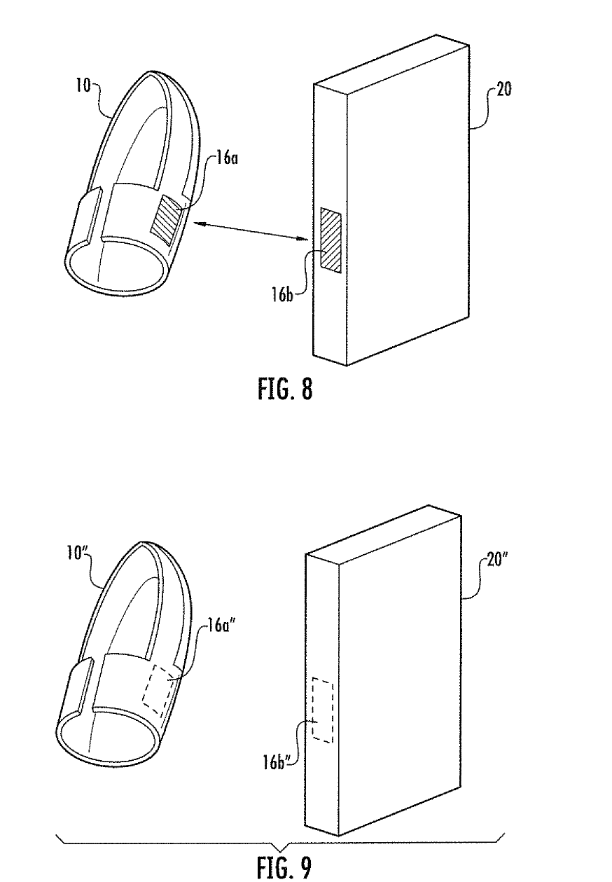

The finger device 10 may further include a storage attachment assembly or area 16 that allows the finger device to be attached to the side of the portable electronic device 20 when not in use, as illustrated in FIGS. 7 and 8. The storage attachment area 16 may be Velcro™, for example. Here, a hook and loop fastener 16a is on the finger device 10, and a hook and loop fastener 16b is on the portable electronic device 20. Other configurations to implement the storage attachment area may be used, such as clips and slides, for example.

As another alternative, the hook and loop fasteners are replaced with magnetic strips 16″, as shown in FIG. 9. This allows the finger device 10″ to be magnetically coupled to the portable electronic device 20″. The finger device 10″ may include a magnetic 16a″ of a first polarity whereas the portable electronic device 20″ carries a magnetic 16b″ that is of a second polarity opposite the first polarity. The magnetic 16b″ carried by the portable electronic device 20″ may be attached by the user to an external surface thereof via an adhesive strip, or the magnet may be integrated internal the device.

The finger device 10 may also be personalized to include decorations. These decorations may be printed on the device itself, or may be attached to the device. The attached decorations may be attached to an upper portion of the finger attachment area 14.

Another aspect is directed to a method of using the finger device 10 to operate a portable electronic device 20 with a capacitive touch screen 22. The method comprises a user positioning a finger into the finger receiving body, and using the finger attachment assembly 16 to securing the finger receiving body to the user's finger. The user then contacts the capacitive touch screen 22 with the electrically conductive material 12 on the bottom surface of the finger device 10 for operating the portable electronic device 20.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included.

That which is claimed:

1. A portable electronic device and a finger device for operating the portable electronic device, and comprising:
said portable electronic device comprising a capacitive touch screen; and
said finger device comprising
a finger receiving body comprising
a bottom surface having a pointed first end and a broad second end, and
a pair of spaced apart sidewalls extending outwards from said bottom surface, and
forming a finger receiving opening at the broad second end and forming a closed tip at the pointed first end;
a finger attachment assembly coupled to said pair of spaced apart sidewalls at the broad second end for securing said finger receiving body to a user's finger; and
an electrically conductive material on a portion of the bottom surface of said finger receiving body and on a portion of said pair of spaced apart sidewalls for contacting said capacitive touch screen for operating said portable electronic device.

2. The portable electronic device and the finger device according to claim 1 wherein said finger attachment assembly comprises hook and loop fasteners.

3. The portable electronic device and the finger device according to claim 1 wherein said finger attachment assembly comprises a pair of curved extensions extending outwards from said pair of spaced apart sidewalls, with a gap between outer exposed ends of said pair of curved extensions.

4. The portable electronic device and the finger device according to claim 3 wherein each curved extension is flexible to accommodate different size fingers.

5. The portable electronic device and the finger device according to claim 3 wherein said finger receiving body and said finger attachment assembly are formed as a single piece.

6. The portable electronic device and the finger device according to claim 1 wherein said finger receiving body comprises flexible plastic.

7. The portable electronic device and the finger device according to claim 1 wherein an upper portion of said finger receiving body is open between the pointed first end and the broad second end to expose an upper portion of the user's finger.

8. The portable electronic device and the finger device according to claim 1 further comprising a storage attachment assembly for attaching said finger device to said portable electronic device when not in use.

9. The portable electronic device and the finger device according to claim 8 wherein said storage attachment assembly comprises hook and loop fasteners.

10. The portable electronic device and the finger device according to claim 8 wherein said storage attachment assembly comprises a first magnetic strip carried by said portable electronic device, and a second magnetic strip carried by said finger device, with said first and second magnetic strips having opposite polarities.

11. The portable electronic device and the finger device according to claim 10 wherein at least one of said first and second magnetic strips is embedded within said portable electronic device and said finger device.

12. A finger device for operating a portable electronic device comprising a capacitive touch screen, and comprising:
a finger receiving body comprising
a bottom surface having a pointed first end and a broad second end, and
a pair of spaced apart sidewalls extending outwards from said bottom surface, and forming a finger receiving opening at the broad second end and forming a closed tip at the pointed first end;
a finger attachment assembly coupled to said pair of spaced apart sidewalls at the broad second end for securing said finger receiving body to a user's finger; and
an electrically conductive material on a portion of the bottom surface of said finger receiving body and on a portion of said pair of spaced apart sidewalls for contacting the capacitive touch screen for operating the portable electronic device.

13. The finger device according to claim 12 wherein said finger attachment assembly comprises hook and loop fasteners.

14. The finger device according to claim 12 wherein said finger attachment assembly comprises a pair of curved extensions extending outwards from said pair of spaced apart sidewalls, with a gap between outer exposed ends of said pair of curved extensions.

15. The finger device according to claim 14 wherein each curved extension is flexible to accommodate different size fingers.

16. The finger device according to claim 14 wherein said finger receiving body and said finger attachment assembly are formed as a single piece.

17. The finger device according to claim 12 wherein said finger receiving body comprises flexible plastic.

18. The finger device according to claim 12 wherein an upper portion of said finger receiving body is open between the pointed first end and the broad second end to expose an upper portion of the user's finger.

19. The finger device according to claim 12 further comprising a storage attachment assembly for attaching said finger receiving body to the portable electronic device when not in use.

20. The finger device according to claim 19 wherein said storage attachment assembly comprises hook and loop fasteners.

21. The finger device according to claim 19 wherein said storage attachment assembly comprises a first magnetic strip carried by the portable electronic device, and a second magnetic strip carried by said finger receiving body, with the first and second magnetic strips having opposite polarities.

22. The finger device according to claim 21 wherein said second magnetic strip is embedded within said finger receiving body.
